(19) United States
(12) Patent Application Publication
(10) Pub. No.: US 2024/0225104 A1
(43) Pub. Date: Jul. 11, 2024

(54) AEROSOL GENERATING APPARATUS INCLUDING FLAVORED CARTRIDGE

(71) Applicant: KT&G CORPORATION, Daejeon (KR)

(72) Inventors: Dong Hyun KIM, Daejeon (KR); Chang Gook LEE, Daejeon (KR); Kyung Bin JUNG, Daejeon (KR); Ho Rim SONG, Daejeon (KR)

(73) Assignee: KT&G CORPORATION, Daejeon (KR)

(21) Appl. No.: 18/008,833

(22) PCT Filed: Oct. 14, 2022
(86) PCT No.: PCT/KR2022/015562

§ 371 Date: Dec. 7, 2022

(30) Foreign Application Priority Data
Oct. 28, 2021 (KR) 10-2021-0145637

(51) Int. Cl. A24F 40/42; A24F 40/46; A24F 40/50

(52) U.S. Cl. CPC A24F 40/42; A24F 40/46; A24F 40/50

(57) ABSTRACT

Provided is an aerosol generating apparatus, including a housing that forms a first accommodation space accommodating an aerosol generating article and a second accommodating space accommodating a cartridge, a cartridge that is accommodated in a second accommodation space located upstream of the aerosol generating apparatus than the first accommodation space and generates an aerosol supplied to the first accommodation space independently of the aerosol generating article, and a controller that controls driving of the aerosol generating apparatus. The cartridge includes a plate-like substrate, a heater introduced on the plate-like substrate, and an aerosol generating coating layer introduced on the heater. According to the aerosol generating apparatus according to an embodiment of the present invention, it is possible to simultaneously implement various flavors according to user's preference at the same time through a small replaceable cartridge.

### TECHNICAL FIELD

The present invention relates to an aerosol generating apparatus including a flavored cartridge. More particularly, the present invention relates to an aerosol generating apparatus including a cartridge that includes an aerosol generating coating layer introduced on a heater.

This application claims the benefit of priority based on Korean Patent Application No. 10-2021-0145637 filed on Oct. 28, 2021, all contents of which are incorporated as a part of the present specification by reference.

### BACKGROUND ART

In recent years, demand for alternative products that overcome the disadvantages of traditional cigarettes is increasing. For example, there is an increasing demand for apparatuses (e.g., cigarette type electronic cigarette) that generate aerosols by electrically heating a cigarette stick. Accordingly, researches on an electrically heated aerosol generating apparatus and a cigarette stick (or aerosol generating articles) applied thereto are being actively conducted.

In order to meet various preferences of consumers, the aerosol generating apparatus and the aerosol generating articles are also changing into various forms. As part of these changes, introducing various flavors into the aerosol generating apparatus or the aerosol generating articles so that consumers may feel various flavors when smoking has also been variously studied in the related art. Even if flavors are introduced into the aerosol generating apparatus or the aerosol generating articles, there are many cases in which one flavor is introduced as a one-off due to problems such as specifications of the apparatus or articles, and there are limitations in applying various flavors at the same time.

Accordingly, the present inventor completed the present invention after studying an aerosol generating apparatus capable of simultaneously applying various perfumes according to consumer's preferences while solving problems such as the above-described standards.

### RELATED ART DOCUMENT

### Patent Document

(Patent Document 1) Korean Patent Laid-Open Publication No. 10-2019-0112162

### DISCLOSURE

### Technical Problem

The present invention provides an aerosol generating apparatus capable of simultaneously implementing various flavors according to user's preference through a small replaceable cartridge.

### Technical Solution

According to a first aspect of the present invention, an aerosol generating apparatus includes
a housing that forms a first accommodation space accommodating an aerosol generating article and a second accommodating space accommodating a cartridge, a cartridge that is accommodated in a second accommodation space located upstream of the aerosol generating apparatus than the first accommodation space and generates an aerosol supplied to the first accommodation space independently of the aerosol generating article, and
a controller that controls driving of the aerosol generating apparatus.

In an embodiment of the present invention, the cartridge may include a plate-like substrate, a heater introduced on the plate-like substrate, and an aerosol generating coating layer introduced on the heater.

In an embodiment of the present invention, the cartridge may include a plurality of heaters and a plurality of aerosol generating coating layers introduced on the plurality of heaters, and each of the plurality of heaters may be separately connected to a circuit that is connected to a controller so as to be independently driven.

In an embodiment of the present invention, in the second accommodation space of the aerosol generating apparatus, the cartridge may be disposed so that a surface of the plate-like substrate into which the heater is not introduced is close to one surface of the second accommodation space, and a flow path extending from the second accommodation space to the first accommodation space may be formed on the surface of the plate-like substrate into which the heater is introduced.

In an embodiment of the present invention, the cartridge may be separated from the aerosol generating apparatus and replaceable.

In an embodiment of the present invention, the aerosol generating apparatus may further include a switch, wherein the switch generates an input signal for driving each of the plurality of heaters, and the input signal is transmitted to the controller.

In an embodiment of the present invention, the aerosol generating coating layer is formed of a porous substrate on which a composition containing an aerosol generating material is supported.

In an embodiment of the present invention, at least one of the plurality of aerosol generating coating layers includes an additive added to the composition, and the additive includes nicotine, perfume, a flavoring agent, vitamin or a combination thereof.

In an embodiment of the present invention, each of the plurality of aerosol generating coating layers is different from each other in a type and content of constituent components.

In an embodiment of the present invention, at least one of the plurality of aerosol generating coating layers has a different size.

In an embodiment of the present invention, the cartridge furthers include a partition vertically disposed on a plate-like substrate to separate each aerosol generating coating layer.

In an embodiment of the present invention, the cartridge further includes a porous cover disposed on the aerosol generating coating layer to separate a flow path and the aerosol generating coating layer.

### Advantageous Effects

The aerosol generating apparatus according to an embodiment of the present invention may simultaneously implement various flavors according to user's preference at the same time through a small replaceable cartridge.

Specifically, the cartridge may include a plurality of aerosol generating coating layers, and each of the plurality of aerosol generating coating layers may be manufactured to have different sizes and shapes as well as a type and content of constituent components, so users may adjust the aerosol flavor according to their preferences.

The aerosol generating apparatus according to an embodiment of the present invention may independently heat a plurality of aerosol generating coating layers included in the cartridge, so users may change an aerosol flavor, etc., even while smoking, if necessary.

### DESCRIPTION OF DRAWINGS

FIG. 1 is a cross-sectional view illustrating an aerosol generating apparatus to which an aerosol generating article is applied according to an embodiment of the present invention.

FIG. 2 is a perspective view illustrating a cartridge in which a heater and a circuit are introduced on a plate-like substrate according to an embodiment of the present invention.

FIG. 3 is a perspective view illustrating a cartridge in which the heater and circuit are introduced on a plate-like substrate and an aerosol generating coating layer is introduced on the heater according to an embodiment of the present invention.

FIG. 4A is a plan view illustrating a cartridge into which an aerosol generating coating layer having a uniform size is introduced according to an embodiment of the present invention.

FIG. 4B is a plan view illustrating a cartridge into which an aerosol generating coating layer having a non-uniform size is introduced according to an embodiment of the present invention.

FIG. 5A is a perspective view illustrating the aerosol generating apparatus before the cartridge is accommodated according to an embodiment of the present invention.

FIG. 5B is a perspective view illustrating the aerosol generating apparatus after the cartridge is accommodated according to the embodiment of the present invention.

FIG. 6A is a front view illustrating a cartridge including a partition according to an embodiment of the present invention.

FIG. 6B is a front view illustrating a cartridge including a partition and a porous cover according to an embodiment of the present invention.

### BEST MODE

Hereinafter, specific embodiments will be described in detail with reference to exemplary drawings. It is to be noted that in giving reference numerals to components of the respective drawings, the same components will be denoted by the same reference numerals even though they are illustrated in different drawings. Further, in describing specific embodiments, well-known constructions or functions will not be described in detail in the case in which it is determined that they may unnecessarily obscure the understanding of specific embodiments of the present disclosure.

In addition, the terms first, second, A, B, (a), (b), and the like may be used in describing components of specific embodiments. These terms are only for distinguishing the components from other components, and the nature, sequence, order, or the like of the components are not limited by the terms. When it is described that any component is “connected” or “coupled” to another component, it is to be understood that any component is directly connected or coupled to another component or is connected or coupled to another component with the other component interposed therebetween.

Components included in any one specific embodiment and components including common functions will be described using the same names in other specific embodiments. Unless described to the contrary, the description described in any one specific embodiment may be applied to other embodiments, and specific descriptions will be omitted to the extent of overlapping.

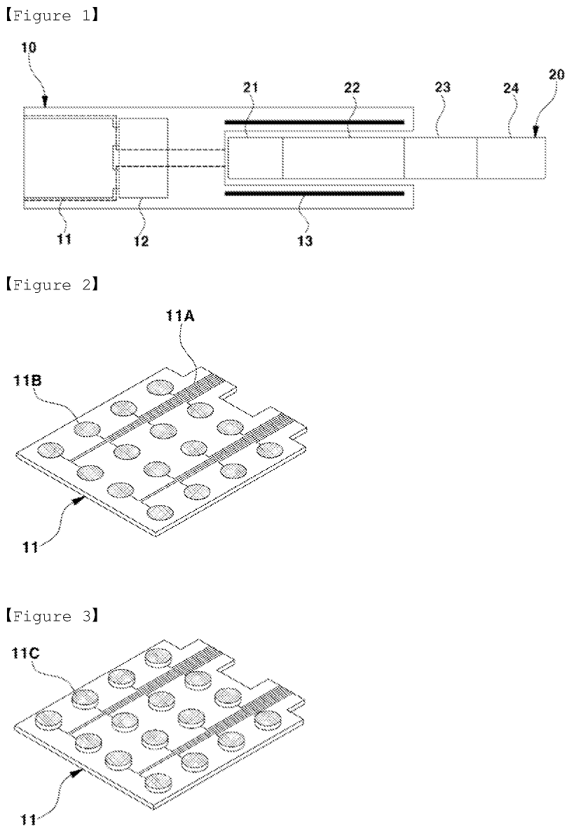

In this specification, the term “aerosol generating apparatus” refers to an apparatus capable of generating an aerosol by applying an aerosol generating article to generate an aerosol that may be directly inhaled into a user's lung through a user's mouth. An exemplary structure of the aerosol generating apparatus will be described with reference to FIG. 1, and the like. An aerosol generating apparatus according to one embodiment of the present invention may accommodate a cartridge and generate an aerosol from the cartridge as illustrated in FIG. 1.

In this specification, the term “aerosol generating article” refers to an article capable of generating an aerosol, such as a cigarette or cigar. The aerosol generating article may include at least one of an aerosol forming agent and an aerosol forming substrate. The aerosol generating article may include several segments each having functionality. In general, the aerosol generating article includes a combustion-type an aerosol generating article that is used by direct fire, a heating-type aerosol generating article that is used along with an aerosol generating apparatus, and the like. In the present invention, the heating-type aerosol generating article used along with the aerosol generating apparatus may be preferably applied.

As used herein, the term “aerosol forming agent” means a substance capable of facilitating the formation of visible smoke and/or aerosol. Examples of the aerosol forming agent include, but are not limited to, glycerin (GLY), propylene glycol (PG), ethylene glycol, dipropylene glycol, diethylene glycol, triethylene glycol, tetraethylene glycol, and oleyl alcohol. In the art, the aerosol forming agent may be used interchangeably with terms such as a moisturizer, a humectant, and the like, as well as terms such as an aerosol generating material.

In this specification, the term “aerosol forming substrate” means a material capable of forming an aerosol. The aerosol may contain volatile compounds. The aerosol forming substrate may be solid or liquid.

For example, a solid aerosol forming substrate may contain a solid material based on tobacco raw materials such as sheet leaf tobacco, cut filler, and reconstituted tobacco, and a liquid an aerosol forming substrate may contain liquid compositions based on nicotine, tobacco extracts, and/or various flavoring agents. However, it is not necessarily limited thereto. The aerosol forming substrate may further include an aerosol forming agent to stably form visible smoke and/or aerosol.

In this specification, the terms “upstream” and “downstream” are terms used to represent relative positions of segments constituting the aerosol generating article based on a direction in which a user inhales air using the aerosol generating article. The aerosol generating article includes an upstream end portion (i.e., a portion through which air enters) and a downstream end portion (i.e., a portion through which air exits) opposite thereto. When using the aerosol generating article, a user may bite the downstream end portion of the aerosol generating article. The downstream end portion is located downstream of the upstream end portion, while the term “end portion” may also be described as “distal end.” Based on the corresponding direction, relative positions of each component may also be indicated in the aerosol generating apparatus to which the aerosol generating article is applied.

In this specification, the term “puff” refers to user's inhalation, and the inhalation refers to a situation in which air is drawn through a user's mouth or nose into a user's oral cavity, nasal cavity, or lung.

In this specification, the term “longitudinal direction” refers to a direction corresponding to a longitudinal axis of the aerosol generating article.

The present invention relates to an aerosol generating apparatus, and provides an aerosol generating apparatus capable of simultaneously implementing various flavors according to user's preference through a small replaceable cartridge. In the present specification, in order to help understand the aerosol generating apparatus, FIG. 1 schematically illustrates a cross section of an exemplary an aerosol generating apparatus. According to an embodiment of the present invention, the aerosol generating apparatus 10 includes a housing, a cartridge 11, and a controller 12. In addition, the aerosol generating apparatus 10 may further include a heater unit 13 for heating an aerosol generating article 20 accommodated in an accommodation space of the housing. Additionally, the aerosol generating apparatus 10 may further include a battery 11, and may further include general-purpose components for those skilled in the art in addition to the above components. For example, the aerosol generating apparatus 10 may further include an input module (e.g., a button, a touchable display, etc.) for receiving a command from a user, or the like, and an output module (e.g., an LED, a display, a vibration motor, etc.) for outputting information such as an apparatus state and smoking information. Hereinafter, each component of the aerosol generating apparatus 10 will be described in detail.

The housing forms an appearance of the aerosol generating apparatus 10. When the appearance of the aerosol generating apparatus 10 is formed, a first accommodation space capable of accommodating the aerosol generating article 20 and a second accommodation space capable of accommodating the cartridge 11 are formed. The second accommodation space may be located upstream of the aerosol generating apparatus than the first accommodation space. In order to move the aerosol generated through the cartridge 11 accommodated in the second accommodation space to the first accommodation space, a flow path is connected between the first accommodation space and the second accommodation space. In FIG. 1 illustrating the aerosol generating apparatus according to the embodiment of the present invention, the second accommodation space and the flow path are shown as broken lines. As illustrated in FIG. 1, the flow path may be disposed so that the aerosol generated through the cartridge 11 may pass through the inside of the aerosol generating article 20. The housing may be preferably formed of a material capable of protecting internal components.

The cartridge 11 is accommodated in the second accommodation space formed by the housing. Since the cartridge 11 contains an aerosol generating material, the cartridge 11 may generate an aerosol independently of the aerosol generating article 20. The aerosol generated from the cartridge 11 may be delivered to the first accommodation space in which the aerosol generating article 20 is accommodated, and may be inhaled by a user along with the aerosol generated from the aerosol generating article 20.

In this specification, FIGS. 2 and 3 schematically illustrate an exemplary cartridge 11 to facilitate understanding of the cartridge 11. According to an embodiment of the present invention, the cartridge 11 includes a plate-like substrate, a heater 11B introduced on the plate-like substrate, and an aerosol generating coating layer 11C introduced on the heater. Since the cartridge 11 has a plate shape, it is possible to secure a sufficient area to which the heater 11B and the aerosol generating coating layer 11C may be applied and minimize a thickness to contribute to the miniaturization of the aerosol generating apparatus 10. For example, when a vertical cross section of the aerosol generating apparatus 10 is elliptical, the cartridge may be applied parallel to a long axis of the ellipse, thereby maximizing an application area.

According to an embodiment of the present invention, the cartridge 11 includes a plurality of heaters 11B and a plurality of aerosol generating coating layers 11C introduced on the plurality of heaters 11B, and each of the plurality of heaters are separately connected to a circuit 11A that may be connected to a controller 12 so as to be independently driven. The heater 11B is driven to heat the aerosol generating coating layer 11C to generate an aerosol. Since the heater 11B may be independently driven through the separately connected circuit 11A, the heater 11B may generate aerosols of various components according to user's preference. For example, the aerosol generating apparatus 10 may be driven so that different flavors are produced for each puff when a user smokes once, and the aerosol generating apparatus 10 may be driven so that two or more different flavors are combined.

According to an embodiment of the present invention, the cartridge 11 in the second accommodation space of the aerosol generating apparatus 10 is disposed so that a surface of the plate-like substrate into which the heater is not introduced is close to one surface of the second accommodation space. With this disposition, the flow path through which fluids such as air or an aerosol may move may be secured at an upper end of the surface where the heater is introduced on the plate-like substrate, and the flow path may extend to the first accommodation space. Here, being close means that the cartridge 11 is located closer to one surface facing the accommodation space than the other surface when the cartridge 11 is accommodated in the accommodation space, and the cartridge 11 may contact the opposite surface of the accommodation space, but is generally accommodated without complete contact in consideration of the ease of replacement.

According to an embodiment of the present invention, the cartridge 11 may be separated from the aerosol generating apparatus 10 and replaced. When the material introduced on the heater is exhausted by the heating of the heater 11B like the aerosol generating article 20, since the cartridge 11 is difficult to have any more functionality, it is necessary to replace the cartridge 11. Since a plurality of aerosol generating coating layers 11C exist in the cartridge 11, the timing when all the exhausted aerosol generating coating layers 11C are generated may vary according to a use method of a user, and even if one an aerosol generating coating layer 11C is completely exhausted, since the cartridge 11 may be replaced after the other aerosol generating coating layers 11C are exhausted, the replacement timing of the cartridge 11 may vary depending on the user. According to an embodiment of the present invention, the aerosol generating coating layer 11C is included in the cartridge 11 in an amount sufficient to smoke 5 or more aerosol generating articles even if the heater is continuously driven during smoking.

According to an embodiment of the present invention, the aerosol generating apparatus 10 further includes a switch through which a user may operate the heater of the cartridge 11. The switch generates an input signal for driving each of the plurality of heaters in the cartridge 11, and the input signal is transmitted to the controller to drive the heater. When the cartridge 11 includes a plurality of heaters, not only one heater but also two or more heaters may be driven simultaneously according to a user's selection. A user may freely adjust an aerosol flavor according to his/her preference by recognizing in advance that a specific heater generates an aerosol with a specific flavor.

The aerosol generating coating layer 11C is manufactured by dropping a composition liquid containing an aerosol generating material or the like into an opening of a frame having the same opening as that of the heater 11B and then drying the aerosol generating coating layer 11C. In this specification, a dried state of the composition liquid is expressed as a composition. The composition liquid may maintain its form as a coating layer by evaporating a solvent or the like during drying, and the coating layer may include a porous substrate to more easily contain the composition. According to an embodiment of the present invention, the aerosol generating coating layer 11C is formed of a porous substrate on which the composition containing the aerosol generating material is supported. Here, the support means a state in which pores of the porous substrate contain a composition. The aerosol generating coating layer basically contains the aerosol generating material, so the material added thereto may move in the form of the aerosol.

As the aerosol generating material, any material that may facilitate the formation of the aerosol commonly used in the art may be used without limitation. The aerosol generating material may be, for example, glycerin, propylene glycol, ethylene glycol, dipropylene glycol, diethylene glycol, triethylene glycol, tetraethylene glycol, oleyl alcohol, or combinations thereof. The porous substrate may be used without limitation as long as it may effectively support the composition containing the aerosol generating material or the like in the related art. The porous substrate may be, for example, polyethylene (PE), polypropylene (PP), polyvinyl chloride (PVC), polyethylene terephthalate (PET), polylactic acid (PLA), cellulose acetate (CA), or a combination thereof.

The aerosol generating coating layer 11C may contain additives added to the composition. As the additives, variety of materials that may be applied in the art in consideration of the user's preference may be used. The additive may be, for example, nicotine, perfume, a flavoring agent, vitamin, or a combination thereof. The nicotine is basically supplied by the aerosol generating article 20, but a nicotine content is already fixed in the aerosol generating article 20. Therefore, it is difficult to control the nicotine content when a specific an aerosol generating article is applied, but when the aerosol generating coating layer 11C containing the nicotine is present in the cartridge 11, the content may be adjusted by exceeding the nicotine content of the aerosol generating article.

The perfume is a material capable of adding a flavor to the aerosol, and various materials that may be applied in the related art may be used. For example, the perfume may include menthol, peppermint, spearmint oil, various fruit flavor components, etc., but is not limited thereto. The flavoring agent is a material that may enhance the flavor of an existing component without directly adding a flavor, such as perfume, and various materials that may be applied in the related art may be used. For example, the flavoring agent may include pyruvic acid, benzoic acid, and the like, but is not limited thereto. The vitamin is added to the aerosol as a nutritional component, and may include, for example, vitamin A, vitamin B, vitamin C, vitamin E, etc., but is not limited thereto.

According to an embodiment of the present invention, each of the plurality of aerosol generating coating layers 11C may be different from each other in a type and content of constituent components. Therefore, a user may basically inhale aerosols of various flavors as many as the number of aerosol generating coating layers, and when two or more heaters 11B are driven simultaneously, aerosols that may be generated may be much more diverse.

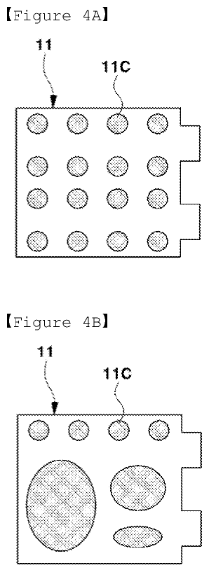

The aerosol generating coating layer 11C may be manufactured in various sizes and shapes. The aerosol generating coating layer 11C is manufactured to have the same size as the heater located at the bottom, and in this specification, a contact area between the aerosol generating coating layer 11C and the heater 11B refers to the size of the aerosol generating coating layer 11C. When the cartridge 11 includes the plurality of aerosol generating coating layers 11C, each aerosol generating coating layer 11C does not necessarily have the same size. In this specification, to help understand the size, shape, arrangement, etc., of the aerosol generating coating layer 11C of the cartridge 11, FIGS. 4A and 4B schematically show an exemplary cartridge 11. As illustrated in FIG. 4A, each of the aerosol generating coating layers 11C may be uniformly manufactured to have the same size and disposed regularly, and as illustrated in FIG. 4B, some of the aerosol generating coating layers 11C may be non-uniformly manufactured in different sizes and disposed regularly. FIGS. 4A and 4B illustrate the shape of a curved circle or ellipse, but the aerosol generating coating layers may also be manufactured into a polygonal shape such as a triangle, a quadrangle, or a pentagon, and when the aerosol generating coating layer 11C may be efficiently disposed in the cartridge 11, the form thereof is not particularly limited.

According to an embodiment of the present invention, at least one of the plurality of aerosol generating coating layers 11C may have different sizes. Exemplarily, the aerosol generating coating layer including the main components of the cartridge 11 may be manufactured larger in consideration of the user's demand. As another example, an aerosol generating coating layer rapidly consumed by a heater may be manufactured larger in consideration of balanced consumption of each aerosol generating coating layer. Compared to the additives, since the aerosol generating material may easily form an aerosol by heating, the aerosol generating coating layer containing a large amount of the aerosol generating material may be manufactured larger. When the size of the aerosol generating coating layer is large, since the contact area between the heater and the aerosol generating coating layer is large, a larger amount of an aerosol may be generated than other aerosol generating coating layers when the heater is driven. Considering this, the heating temperature of the heater may be adjusted according to the size of the aerosol generating coating layer so that the same or similar amount of an aerosol may be generated in each aerosol generating coating layer.

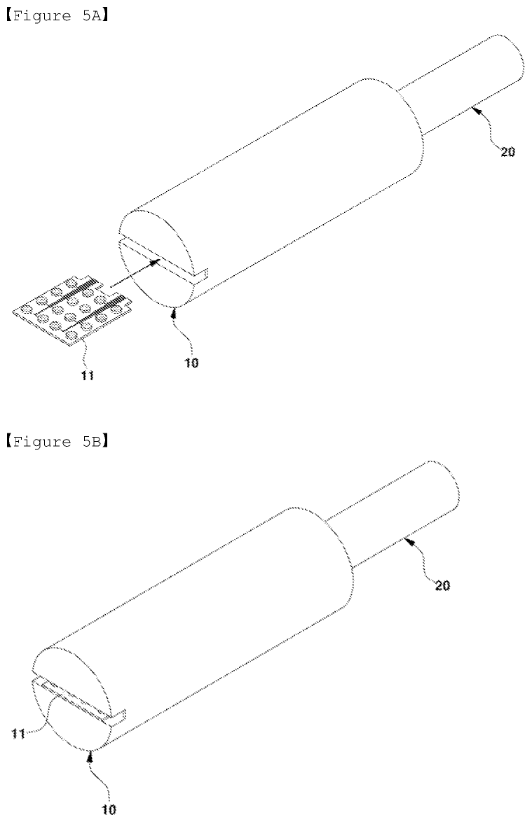

In the aerosol generating apparatus 10, the cartridge 11 may be introduced into the aerosol generating apparatus 10 from the outside, and when the aerosol generating coating layer 11C of the cartridge 11 is exhausted, the cartridge 11 may be separated and replaced. In this specification, to help understand the introduction of the cartridge 11 from the outside, FIGS. 5A and 5B schematically illustrate the positional relationship between the exemplary cartridge 11 and the aerosol generating apparatus 10. As illustrated in FIG. 5A, the second accommodation space for accommodating the cartridge 11 in the aerosol generating apparatus 10 is located at one end portion of the aerosol generating apparatus 10, so the external cartridge 11 may move in a direction horizontal to the longitudinal direction of the aerosol generating apparatus 10 and may be accommodated in the second accommodation space of the aerosol generating apparatus 10.

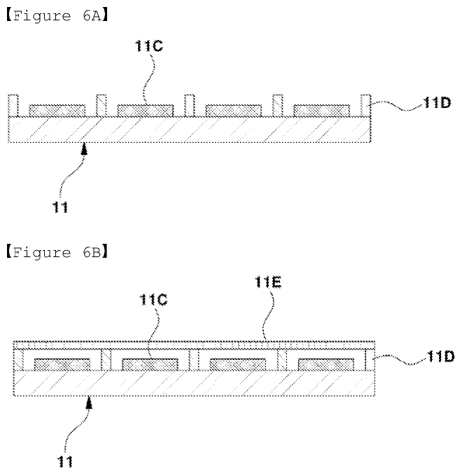

After the cartridge 11 is accommodated in the second accommodation space, the aerosol generated from the aerosol generating coating layer 11C of the cartridge 11 may move to the first accommodation space by the horizontal flow to longitudinal direction of the aerosol generating apparatus 10 in the flow path located on the upper portion of the cartridge 11. When the aerosol generating coating layer 11C is exposed to such a horizontal flow as it is, components may leak from the aerosol generating coating layer on the heater 11B that is not heated, and thus a flavor unintended by a user may be mixed in an aerosol. To solve this problem, the cartridge 11 may further include a partition 11D vertically disposed on the plate-like substrate. In this specification, to help understand the cartridge 11 to which the partition 11D is applied, FIG. 6A schematically shows the exemplary cartridge 11. Each of the aerosol generating coating layers 11C may be spatially separated by the partition 11D. As illustrated in FIG. 6A, the partition 11D may be installed higher than the height of the aerosol generating coating layer 11C in order to secure functionality. According to an embodiment of the present invention, the partition 11D may be made of the same material as the plate-like substrate.

Similar to the partition 11D, the cartridge 11 may further include a porous cover 11E disposed on the aerosol generating coating layer in order to solve the problem in which the flavors unintended by the user are mixed with the aerosol. In this specification, to help understand the cartridge 11 to which the porous cover 11E is applied, FIG. 6B schematically shows the exemplary cartridge 11. As illustrated in FIG. 6B, the porous cover 11E may be applied along with the partition 11D, but may be applied alone even without the partition 11D to secure functionality. The porous cover 11E is sufficient to be disposed to separate the flow path and the aerosol generating coating layer, and therefore, is not necessarily located in contact with the aerosol generating coating layer. The porous cover 11E may prevent the flow of fluid in the flow path from contacting the aerosol generating coating layer 11C without preventing the aerosol generated from the aerosol generating coating layer 11C from moving in the direction perpendicular to the longitudinal direction of the aerosol generating apparatus 10 and joining the flow path. As long as the porous cover 11E has the above functionality, the material or shape of the porous cover 11E is not particularly limited. The porous cover 11E may be made of the same or similar material as the porous substrate included in the aerosol generating coating layer 11C, but may secure the above-described functionality through a mesh having a plurality of openings regardless of the material.

The aerosol generating apparatus 10 may further include a heater 13 for heating an aerosol generating article 20 accommodated in the first accommodation space of the housing separately from the heater included in the cartridge 11. When the aerosol generating article 20 is accommodated in the accommodation space of the aerosol generating apparatus 10, the heater 13 may heat the aerosol generating article 20 by power supplied from the battery 11.

The heater 13 in the housing along with the heater 11B in the cartridge 11 may be configured in various shapes and/or manners.

The heater 13 may be configured to include, for example, an electrical resistive heating element. For example, the heater 13 may include an electrically insulating substrate (for example, a substrate made of polyimide) and an electrically conductive track, and include a heating element that generates heat as current flows through the electrically conductive track. However, the heater 13 is not limited thereto, and the heating element may be applicable without limitation as long as it may be heated to a desired temperature. Here, the desired temperature may be preset (for example, when a temperature profile is pre-stored) in the aerosol generating apparatus 10 or may be set to a desired temperature by a user.

As another example, the heater 13 may be configured to include a heating element operating in an induction heating method. Specifically, the heater 13 may include an inductor (e.g., an induction coil) for heating the aerosol generating article 20 by the induction heating method and a susceptor for induction heating by the inductor. The susceptor may be located inside or outside the aerosol generating article 20.

As another example, the heater unit 13 may be configured to include a heating element (hereinafter referred to as an “internal heating element”) for internally heating the aerosol generating article 20 and a heating element (hereinafter referred to as “external heating element”) for externally heating the aerosol generating article 20, or a combination thereof. The internal heating element may have, for example, a tubular shape, a needle shape, a rod shape, or the like, and may be disposed to penetrate through at least a portion of an aerosol generating article 20. The external heating element may be formed in a shape such as a plate shape or a cylinder shape and may be disposed in a shape that encloses at least a portion of the aerosol generating article 20. However, the scope of the present disclosure is not limited thereto, and the shape, number, and arrangement of heating elements may be designed in various ways.

The battery supplies power used to operate the aerosol generating apparatus 10. For example, the battery may supply power so that the heaters 11B and 13 may heat the aerosol generating article 20 and supply power necessary for the controller 12 to operate. In addition, the battery may supply power necessary for operating electrical components such as a display, a sensor, and a motor installed in the aerosol generating apparatus 10.

The controller 12 may control driving of the aerosol generating apparatus 10 as a whole. For example, the controller 12 may control driving of the heaters 11B and 13 and the battery, and may also control driving of other components included in the aerosol generating apparatus 10. The controller 12 may control power supplied by the battery, and may also control the heating temperature or the like of the heaters 11B and 13. As described above, when the heater 11B is formed of a plurality of heaters, the controller 12 may control the temperature of each heater 11B to be separately adjusted. In addition, the controller 12 may check the state of each component of the aerosol generating apparatus 10 to determine whether the aerosol generating apparatus 10 is in a drivable state.

The controller 12 may be implemented by at least one processor. The controller may be implemented as an array of a plurality of logic gates, or may be implemented as a combination of a general-purpose microcontroller and a memory storing programs that may be executed by the microcontroller. In addition, those skilled in the art may clearly understand that the controller 12 may be implemented with other types of hardware.

The aerosol generating article 20 applied to the aerosol generating apparatus 10 may have a structure similar to that of a general combustion type cigarette. The aerosol generating article 20 may be divided into, for example, a first part (e.g., a tobacco rod) including a tobacco substance (or an aerosol forming substrate) and a second part (e.g., a filter rod) including a filter and the like. The entire first part may be inserted into the aerosol generating apparatus 10, and the second part may be exposed to the outside. Alternatively, only a portion of the first portion may be inserted into the aerosol generating apparatus 10, or the entire first portion and a portion of the second portion may be inserted. A user may smoke while holding the second part with his or her mouth. A structure of the exemplary aerosol generating article 20 applied to the aerosol generating apparatus 10 may be described with reference to FIG. 1.

According to an embodiment of the present invention, the first part includes a first aerosol generator 21 and a second aerosol generator 22. The first aerosol generator 21 is located at the most upstream from the aerosol generating article 20, and air entering from the upstream end portion of the aerosol generating article first passes through the first aerosol generator. The second aerosol generator 22 is disposed on one side of the first aerosol generator 21, and the other side where the second aerosol generator is not disposed naturally becomes the upstream end portion of the aerosol generating article 20.

The first aerosol generator 21 includes a porous substrate such as cellulose acetate, and the second aerosol generator 22 includes a tobacco cut filler, so the first aerosol generator 21 and the second aerosol generator 22 are structurally differentiated. The tobacco cut filler may be produced by finely cutting tobacco sheets (or platelet sheets). Since both the porous substrate in the first aerosol generator 21 and the tobacco cut filler in the second aerosol generator 22 are impregnated with an aerosol generating composition, aerosols may be generated by means such as heating. Unlike the first aerosol generator 21, the second aerosol generator 22 has a main purpose of nicotine transfer, so rather than containing a large amount of the aerosol generating composition, it is important to transfer a sufficient amount of nicotine to the aerosol generated from the first aerosol generator 21 by increasing the nicotine content rather than containing a large amount of aerosol generating composition. Considering such functionality, as a reconstituted tobacco sheet that may be used in the second aerosol generator 22, a slurry-type reconstituted tobacco sheet according to a slurry-type method may be preferably used rather than a paper-made reconstituted tobacco sheet according to a paper-making method. When using the slurry-type reconstituted tobacco sheet, one or more of tobacco dust, tobacco fines and other particulate tobacco by-products formed during processing, handling and shipping of tobacco may be added to increase the nicotine content.

In the aerosol generating article 20, the first part may include tobacco granules other than tobacco cut filler. In this case, the aerosol generating article 20 may include a first filter segment, a second filter segment, and a cavity segment. The cavity segment is formed by a first filter segment and a second filter segment. The first filter segment, the second filter segment, and the cavity segment are components included in the above-described first part (or tobacco rod), and supply tobacco components (or flavor components) such as nicotine as the first portion is heated. Regarding the tobacco component in the first part, the cavity segment may be filled with tobacco granules, which are tobacco substances in the form of granules. The first filter segment and the second filter segment basically have functionality as a filter, but also have a function of designating a compartment in which the tobacco granules may be retained without leaking when the tobacco granules are filled in the cavity segment. The first part including the first filter segment, the second filter segment, and the cavity segment may be wrapped with a wrapper.

The aerosol generating article 20 according to an embodiment of the present invention may further include a first filter unit 23 and a second filter unit 24. The first filter unit 23 is disposed on one side (downstream side) of the second aerosol generator 22, and the second filter unit 24 is disposed on one side (downstream side) of the first filter 23. When the aerosol generating article 20 includes the first aerosol generator 21, the second aerosol generator 22, the first filter unit 23, and the second filter unit 24 as illustrated in FIG. 1, the aerosol generating apparatus 10 to be described later may heat at least a portion of the first aerosol generator 21 and the second aerosol generator 22 to generate aerosol, and the generated aerosol may sequentially pass through the first filter unit 23 and the second filter unit 24 to be delivered to the user.

The aerosol generating article 20 applied to the aerosol generating apparatus 10 according to the present invention is not particularly limited as long as it is used as a heating-type aerosol generating article in the related art. In the aerosol generating apparatus 10, the heater may be deformed and applied in an appropriate form to effectively heat the aerosol generator in the aerosol generating article 20.

As described above, although the embodiments have been described by the limited embodiments and drawings, various modifications and alternations are possible by those of ordinary skill in the art from the above description. For example, even though the described techniques may be performed in a different order than the described method, and/or components of the described systems, structures, devices, circuits, etc., may be combined or combined in a different manner than the described method, or replaced or substituted by other components, appropriate results may be achieved.

### DETAILED DESCRIPTION OF MAIN ELEMENTS

10: Aerosol generating apparatus
11: Cartridge
11A: Circuit
11B: Heater (in cartridge)
11C: Aerosol generating coating layer
110: Partition
11E: Porous cover
12: Control unit
13: Heater (in housing)
20: Aerosol generating article
21: First aerosol generator
22: Second aerosol generator
23: First filter unit
24: Second filter unit

1. An aerosol generating apparatus, comprising:
a housing that forms a first accommodation space accommodating an aerosol generating article and a second accommodating space accommodating a cartridge;
a cartridge that is accommodated in a second accommodation space located upstream of the aerosol generating apparatus than the first accommodation space and generates an aerosol supplied to the first accommodation space independently of the aerosol generating article; and
a controller that controls driving of the aerosol generating apparatus,
wherein the cartridge includes a plate-like substrate, a heater introduced on the plate-like substrate, and an aerosol generating coating layer introduced on the heater.

2. The aerosol generating apparatus of claim 1, wherein the cartridge comprises a plurality of heaters and a plurality of aerosol generating coating layers introduced on the plurality of heaters, and
each of the plurality of heaters is separately connected to a circuit that is connected to a controller so as to be independently driven.

3. The aerosol generating apparatus of claim 1, wherein, in the second accommodation space of the aerosol generating apparatus, the cartridge is disposed so that a surface of the plate-like substrate into which a heater is not introduced is close to one surface of the second accommodation space, and a flow path extending from the second accommodation space to the first accommodation space is formed on the surface of the plate-like substrate into which the heater is introduced.

4. The aerosol generating apparatus of claim 1, wherein the cartridge is separated from the aerosol generating apparatus and replaceable.

5. The aerosol generating apparatus of claim 2, further comprising a switch,
wherein the switch generates an input signal for driving each of the plurality of heaters, and the input signal is transmitted to the controller.

6. The aerosol generating apparatus of claim 2, wherein the aerosol generating coating layer is formed of a porous substrate on which a composition containing an aerosol generating material is supported.

7. The aerosol generating apparatus of claim 6, wherein at least one of the plurality of aerosol generating coating layers comprises an additive to the composition, and
the additive comprises nicotine, perfume, a flavoring agent, vitamin or a combination thereof.

8. The aerosol generating apparatus of claim 7, wherein each of the plurality of aerosol generating coating layers is different from each other in a type and content of constituent components.

9. The aerosol generating apparatus of claim 2, wherein at least one of the plurality of aerosol generating coating layers has a different size.

10. The aerosol generating apparatus of claim 2, wherein the cartridge further comprises a partition vertically disposed on a plate-like substrate to separate each aerosol generating coating layer.

11. The aerosol generating apparatus of claim 2, wherein the cartridge further comprises a porous cover disposed on the aerosol generating coating layer to separate a flow path and the aerosol generating coating layer.
